(19) United States
(12) Patent Application Publication
(10) Pub. No.: US 2010/0142885 A1
(43) Pub. Date: Jun. 10, 2010

(54) OPTICAL MODULE

(75) Inventors: Kazunori SHINODA, Musashino (JP); Hideo ARIMOTO, Kodaira (JP); Masahiro AOKI, Kokubunji (JP); Koichiro ADACHI, Musashino (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/629,218

(22) Filed: Dec. 2, 2009

(30) Foreign Application Priority Data
Dec. 9, 2008 (JP) 2008-313543

(51) Int. Cl. G02B 6/12; G02B 6/26

(52) U.S. Cl. 385/14; 385/50

(57) ABSTRACT

The first and second optical waveguide device portions are optically coupled by 45-degree total reflection mirrors integrally formed in the respective device portions. The light generated by the first optical waveguide device portion is bent upward by the total reflection mirror of the first optical waveguide device portion. The light is totally reflected by the 45-degree total reflection mirror of the second optical waveguide device portion, and coupled to the second optical waveguide device portion. The first optical waveguide device portion has a lens device for focusing the emitted light onto a light emitting portion. The second optical waveguide device portion has a lens device for focusing the incident light onto a light receiving portion.

### CLAIM OF PRIORITY

The present application claims priority from Japanese patent application JP 2008-313543 filed on Dec. 9, 2008, the content of which is hereby incorporated by reference into this application.

### BACKGROUND OF THE INVENTION

1. Field of the Invention

The present invention relates to an optical module, and more particularly, to an optical module such as an optical transceiver module including an integrated photonic device as a component fabricated by integrating a plurality of optical waveguide device portions such as a semiconductor laser and an optical modulator.

2. Description of the Related Arts

With the rapid increase in the amount of data traffic on the network due to the spread of broadband services through the Internet or other electronic and wireless services, there has been an active increase in the capacity of the long haul network between large cities or continents as well as the metro network connecting neighboring cities.

Under these circumstances, the technique for increasing the system capacity has been more and more important not only in the conventional telecommunication network, but also in the data communication network such as storage area network and Ethernet. The throughput of such high-speed interface devices is limited by the packaging density defined by the module size and power consumption, in addition to the speed per channel.

Thus, the reduction in size of the optical module is an important issue. For example, in the optical transmitter module of 10 Gbps, the existing relatively large 300-pin modules are expected to be replaced with smaller modules such as 10-Gigabit Ethernet transceiver package (XENPAK) and 10-Gigabit small form factor pluggable (XFP) modules.

For this reason, the reduction in the size of the photonic device to be installed in the optical module is an important development issue. The key technique for achieving a compact optical module is photonic device integration technique. For example, in the transceiver module for long-haul transmission in the metro network, a method for providing a compact transceiver has been put into practice by means of a distributed feedback (DFB) laser light source in which a semiconductor electro absorption (EA) modulator is monolithically integrated on the transmission side.

For example, butt joint technique is an example of a typical method for integrating a plurality of optical waveguide devices such as a semiconductor laser and an optical modulator.

The butt joint technique is a technique for butt-joining a plurality of optical waveguides to integrate them on a single substrate. The fabrication procedure is as follows. A first optical waveguide is first formed on a semiconductor substrate by epitaxial growth. Then, a part of the first optical waveguide is covered with a mask pattern to remove the portion of the first optical waveguide not covered with the mask pattern by etching. Next, a second optical waveguide is grown by metal organic vapor phase epitaxy (MOVPE) and is joined to the etched portion of the first optical waveguide. The above steps are repeated necessary times.

In this technique, it is possible to individually optimize the material, composition, number of layers, and film thickness of each optical waveguide multilayer structure. Thus, the technique is widely used as a method for fabricating a high performance integrated photonic device, compared to a method for simultaneously forming a plurality of optical waveguides by a single selective growth.

As a known example of the conventional integrated photonic device technique, Japanese Patent Application Laid-Open Publication No. 2002-324936 describes an example of a photonic device in which an EA modulator and a DFB laser are integrally formed with an optical waveguide between them on a signal substrate. Further, Japanese Patent Application Laid-Open Publication No. 2006-253525 describes an example of an integrated photonic device in which a wavelength tunable laser array, a multi mode interferometer, and a semiconductor optical amplifier are integrally formed by the butt joint technique. Further, Japanese Patent Application. Laid-Open Publication No. 2004-273906 describes a photonic device formed by stacking an optical amplifier and a vertical laser for irradiating a laser beam in a direction perpendicular to the substrate surface.

### SUMMARY OF THE INVENTION

The conventional integrated photonic device is fabricated by integrating a plurality of optical waveguides to each other on a single substrate surface. For example, Japanese Patent Application Laid-Open Publication No. 2002-324936 describes an example of an integrated photonic device fabricated by integrating an EA modulator, a bulk optical waveguide, and a DFB laser, in such a way that the EA modulator, the bulk optical waveguide, and the DFB laser are linearly joined together on a single substrate.

Also in Japanese Patent Application Laid-Open Publication No. 2006-253525, an integrated photonic device is fabricated by integrating a wavelength tunable laser array, a multi mode interferometer, and a semiconductor optical amplifier, in such a way that the wavelength tunable laser array, the multi mode interferometer, and the semiconductor optical amplifier are aligned with their waveguides joined together on a signal substrate.

However, such two-dimensionally integrated configurations have a problem that when the number of optical waveguide devices to be integrated is increased, the length of the device is monotonically increased in accordance with the integrated number.

Thus, the conventional two-dimensional integration technique has limitations in achieving an integrated photonic device having a short length to meet the installation requirements of the next-generation compact optical module. For example, FIGS. 1A and 1B are diagrams of an integrated photonic device in which a wavelength tunable semiconductor laser 11, a semiconductor optical amplifier 12, and a Mach-Zehnder (MZ) modulator 13 are two-dimensionally integrated by the conventional butt joint technique. FIG. 1A is a top view and FIG. 1B is a cross-sectional view. More specifically, FIG. 1B shows a cross-sectional structure taken along the dotted line (A to B) in the top view of FIG. 1A.

The wavelength tunable semiconductor laser 11 has a structure in which a laser gain region 22 is sandwiched between a rear sampled grating DBR 21 and a front sampled granting DBR 23. In FIGS. 1A and 1B, reference numeral 14 denotes an anti-reflective coating, reference numeral 15 denotes a p-electrode for the rear sampled grating DBR, reference numeral 16 denotes a p-electrode for the laser gain region, and reference numeral 17 denotes a p-electrode for the front sampled grating DBR.

The semiconductor optical amplifier 12 has an amplifier gain region 24. The structure of the amplifier gain region 24 is the same as the structure of the laser gain region 22. In FIGS. 1A and 1B, reference numeral 18 denotes a p-electrode for the optical amplifier.

The Mach-Zehnder modulator 13 has a pair of multimode interference (MMI) couplers 19. In FIGS. 1A and 1B, reference numeral 20 denotes a phase modulation p-electrode, reference numeral 25 denotes a modulator optical waveguide, and reference numeral 26 denotes an n-electrode.

In the integrated photonic device shown in FIGS. 1A and 1B, the device length of the wavelength tunable semiconductor laser 11 is 1.5 mm, the device length of the semiconductor optical amplifier 12 is 0.5 mm, and the device length of the Mach-Zehnder modulator 13 is 2 mm. As a result, the total device length of the integrated photonic device reaches 4 mm.

However, the next-generation optical module requires the device length of the integrated photonic device of at most 2 mm. It is difficult to achieve such a short device length in the conventional integrated photonic device.

Japanese Patent Application Laid-Open Publication No. 2004-273906 describes a technique for irradiating a laser beam from a vertical laser in a direction perpendicular to the substrate surface, reflecting the laser beam by a reflection mirror, and inputting the reflected light into an optical amplifier. However, there is no description in Japanese Patent Application Laid-Open Publication No. 2004-273906 about the achievement of an integrated photonic device having a short length to meet the installation requirements of the next-generation compact optical module.

The present invention has been made to solve the above problem, and aims to provide a technique capable of achieving a compact optical module by installing an integrated photonic device having a short total device length.

The aforementioned and other objects and novel features of the present invention will become apparent from the description of the present specification and the accompanying drawings.

A summary of representative aspects of the invention disclosed in the present application will be described in brief as follows.

(1) An optical module including an integrated photonic device fabricated by integrating a plurality of optical waveguide devices. The integrated photonic device has a first optical waveguide device portion and a second optical waveguide device portion that are three-dimensionally stacked in a direction perpendicular to a substrate. The first optical waveguide device portion has a reflector for emitting light in a direction perpendicular to a surface of the substrate, so that the emitted light propagates through a first optical waveguide. The second optical waveguide device portion has a reflector for introducing light incident from the direction perpendicular to the surface of the substrate, into a second optical waveguide.
(2) In paragraph (1), the first optical waveguide device portion is mounted on a submount, and the second optical waveguide device portion is mounted on the first optical waveguide device portion.
(3) In paragraph (2), an electrode is formed in a region in which the length in the direction orthogonal to the extending direction of the first optical waveguide in the first optical waveguide device portion, is longer than the length in the direction orthogonal to the extending direction of the first waveguide in the second optical waveguide device portion mounted on the first optical waveguide device portion, and in which the first optical waveguide device portion does not contact the second optical waveguide device portion.
(4) An optical module including an integrated photonic device fabricated by integrating a plurality of optical waveguide devices. The integrated photonic device has a first optical waveguide device portion and a second optical waveguide device portion that are three-dimensionally stacked in a direction perpendicular to a substrate. The first optical waveguide device portion has a reflector for emitting light in a direction perpendicular to a surface of the substrate, so that the emitted light propagates through a first optical waveguide. The second optical waveguide device portion has a reflector for introducing light incident from the direction perpendicular to the surface of the substrate, into a second optical waveguide. The first and second optical waveguide device portions are mounted on submounts with different heights, respectively. The first optical waveguide of the first optical waveguide device portion, and the second optical waveguide of the second optical waveguide device portion are not linearly continued but are bent to each other in the joint portion, when projected in the direction perpendicular to the main surface of the substrate.
(5) In paragraph (4), the first optical waveguide device portion has a structure for operating with TM polarization, and the second optical waveguide device portion has a structure for operating with TE polarization.
(6) In paragraph (4), the first optical waveguide device portion has a structure for operating with TE polarization, and the second optical waveguide device portion has a structure for operating with TM polarization.
(7) In any one of paragraphs (1) to (6), the first optical waveguide device portion has a lens device for focusing the emitted light onto a light emitting portion for emitting light in the direction perpendicular to the surface of the substrate. The second optical waveguide device portion has a lens device for focusing the incident light onto a light receiving portion for receiving light incident from the direction perpendicular to the surface of the substrate.
(8) In any one of paragraphs (1) to (7), the first optical waveguide device portion has at least one wavelength tunable laser and at least one semiconductor optical amplifier. The second optical waveguide device portion has at least one optical modulator.

Effects obtained by a typical one of the inventions disclosed in the present application will be described in brief as follows.

According to the present invention, it is possible to provide an integrated photonic device having a short device length. As a result, it is possible to achieve a very compact optical module by installing the integrated photonic device according to the present invention.

### BRIEF DESCRIPTION OF THE DRAWINGS

FIGS. 1A and 1B are diagrams showing an integrated photonic device in which a wavelength tunable semiconductor laser, a semiconductor optical amplifier, and a semiconductor Mach-Zehnder modulator are two-dimensionally integrated with the conventional butt-joint technique;

FIGS. 2A and 2B are diagrams showing an example of the integrated photonic device in which the wavelength tunable laser, the optical amplifier, and the semiconductor Mach-Zehnder modulator are monolithically integrated with a method according to the present invention;

FIGS. 3A and 3B are diagrams showing another example of the integrated photonic device in which the wavelength tunable laser, the optical amplifier, and the semiconductor Mach-Zehnder modulator are monolithically integrated with the method according to the present invention;

FIGS. 4A and 4B are diagrams showing an example of an integrated photonic device to be installed in an optical module according to an embodiment of the present invention;

FIGS. 5A to 5G are cross-sectional views showing the fabrication procedure of a semiconductor laser portion of the integrated photonic device shown in FIGS. 4A and 4B;

FIG. 6 is a cross-sectional view in the plane intersecting the light traveling direction in the semiconductor laser portion of the integrated photonic device shown in FIGS. 4A and 4B;

FIGS. 7A to 7C are diagrams showing another example of the integrated photonic device to be installed in the optical module according to the embodiment of the present invention; and

FIGS. 8A and 8B are diagrams showing the optical module according to the embodiment of the present invention.

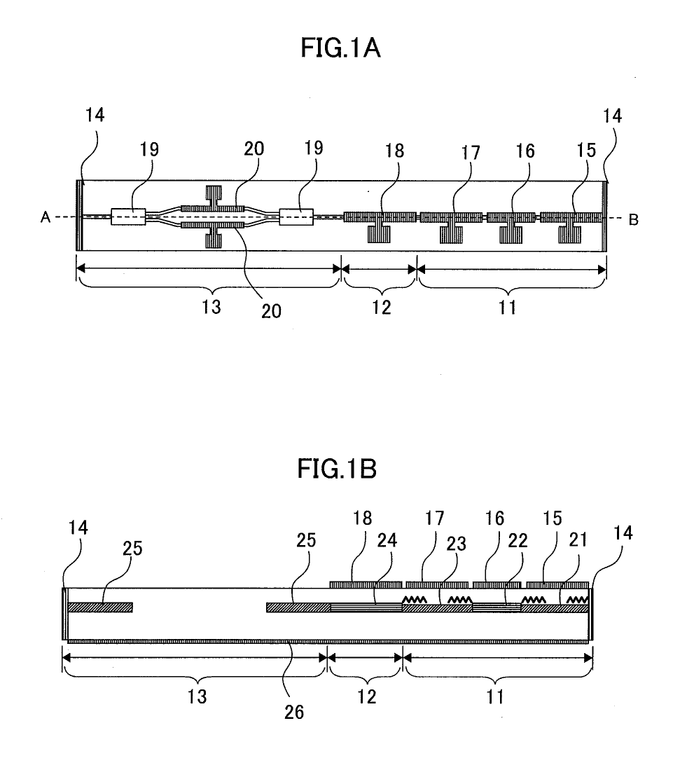

### DETAILED DESCRIPTION OF THE PREFERRED EMBODIMENTS

Hereinafter, an embodiment of the present invention will be described with reference to the accompanying drawings.

It should be noted that components having the same function are denoted by the same reference numerals throughout the drawings for describing the embodiment, and the repetitive description thereof will be omitted.

### BRIEF SUMMARY OF THE PRESENT INVENTION

The feature of the present invention is to reduce the total length of an integrated photonic device by three-dimensionally integrating optical waveguide devices in a direction perpendicular to a surface of a wafer.

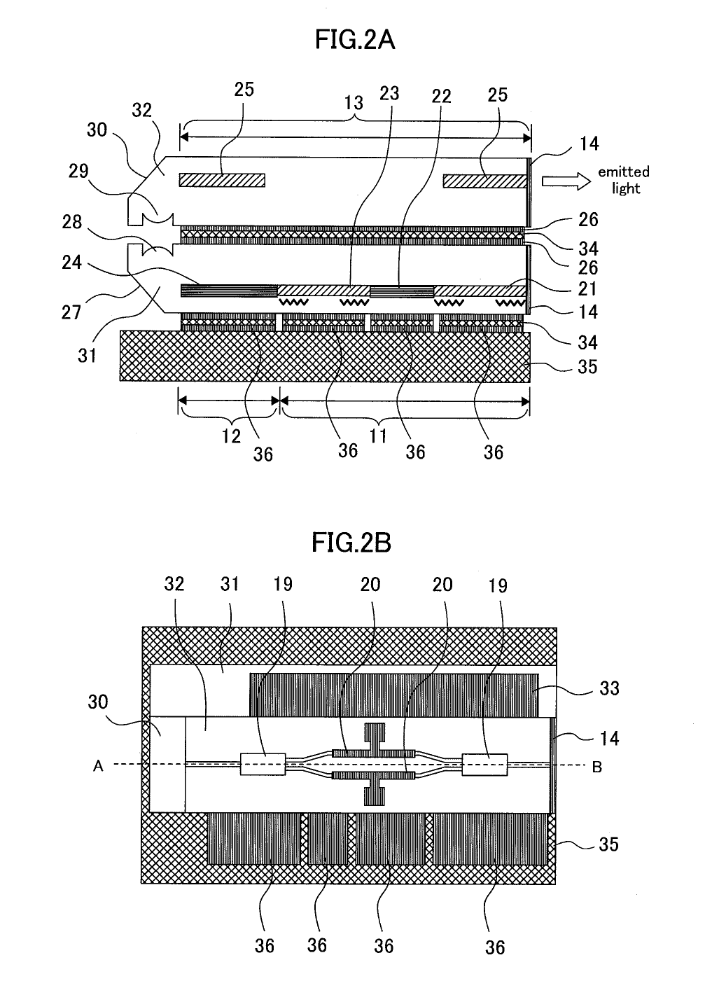

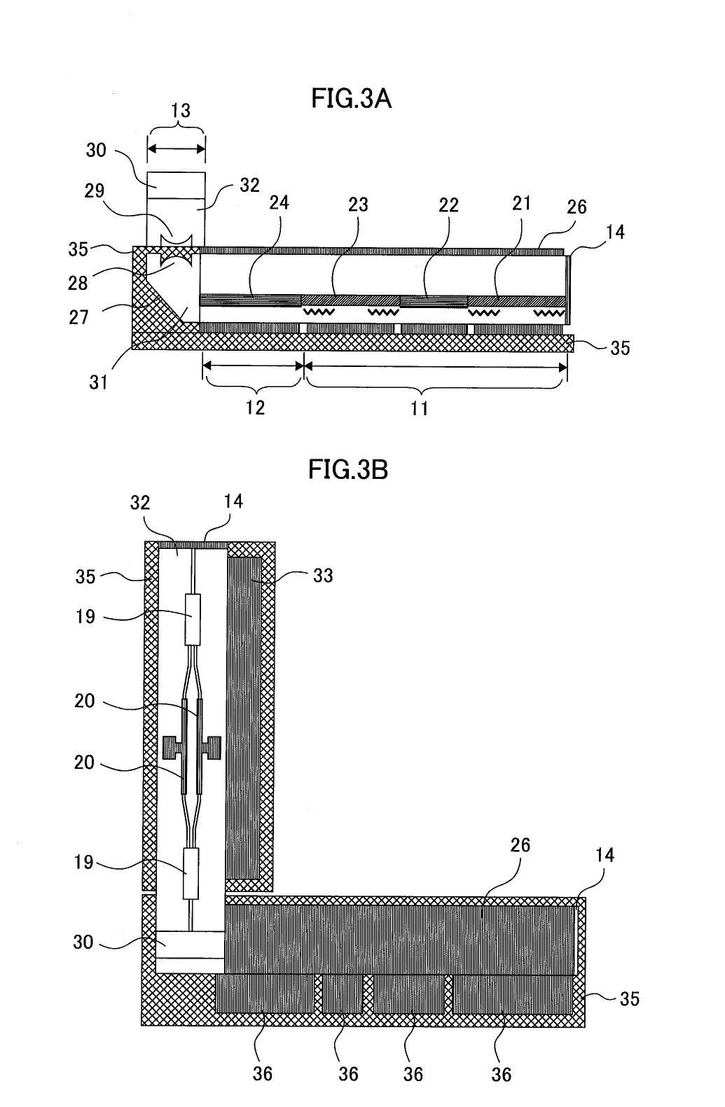

The structure of an integrated photonic device according to the present invention will be described below with reference to FIGS. 2A, 2B and FIGS. 3A, 3B.

FIGS. 2A and 2B are diagrams showing an example of an integrated photonic device in which a wavelength tunable semiconductor laser 11, a semiconductor optical amplifier 12, and a semiconductor Mach-Zehnder modulator 13 are monolithically integrated by a method according to the present invention. FIG. 2A is a cross-sectional view and FIG. 2B is a top view. More specifically, FIG. 2A is a cross-sectional view showing the cross-sectional structure taken along the dotted line A-B in the top view of FIG. 2B.

As shown in FIGS. 2A and 2B, the integrated photonic device has an integrated structure in which two upper and lower photonic devices are three-dimensionally stacked and directly joined with a solder 34 or other suitable bonding material.

A lower photonic device 31 is a photonic device in which the wavelength tunable semiconductor laser 11 and the semiconductor optical amplifier 12 are butt-joined together by the conventional integration method. An upper photonic device 32 is a semiconductor Mach-Zehnder modulator 13.

The wavelength tunable semiconductor laser 11 has a structure in which a laser gain region 22 is sandwiched between a rear sampled grating DBR 21 and a front sampled granting DBR 23. The semiconductor optical amplifier 12 has an amplifier gain region 24. The structure of the amplifier gain region 24 is the same as the structure of the laser gain region 22. The semiconductor Mach-Zehnder modulator 13 has a pair of MMI couplers 19.

In FIGS. 2A and 2B, reference numeral 14 denotes an anti-reflective coating, reference numeral 20 denotes a phase modulation p-electrode, reference numeral 25 denotes a modulator optical waveguide, reference numeral 26 denotes an n-electrode, reference numerals 33 and 36 denote extractor electrodes, and reference numeral 35 denotes a submount.

The two upper and lower photonic devices (31, 32) are optically coupled by total reflection mirrors (27, 30) and lens devices (28, 29). The total reflection mirrors (27, 30) and the lens devices (28, 29) are integrally formed in the upper and lower photonic devices (31, 32), respectively.

A laser beam generated by the wavelength tunable semiconductor laser 11 is amplified by the semiconductor optical amplifier 12. The amplified light is bent upward by the total reflection mirror 27 integrally formed at the front of the semiconductor optical amplifier 12. The light emitted from the lower photonic device 31 is collimated (narrowed or focused) by the lens device 28 integrally formed in a light emitting portion of the lower photonic device 31. Then, the light is incident to the upper photonic device 32.

In the upper photonic device 32, the light is focused by the lens device 29 integrally formed in a light receiving portion. The light is bent by the total reflection mirror 30 integrally formed in the upper photonic device 32. The light is coupled to the modulator optical waveguide 25 of the semiconductor Mach-Zehnder modulator 13, and is modulated by the semiconductor Mach-Zehnder modulator 13. Then, the modulated laser beam is emitted from an end surface of the upper photonic device 32 in which the mirror and lens device are not formed.

As described above, in the integrated photonic device shown in FIGS. 2A and 2B, the optical waveguide device portions are three-dimensionally integrated, so that the length of the device can be reduced to about half the length of the conventional two-dimensionally integrated device in which the optical waveguide devices are integrally joined together in the transverse direction.

Further, in the structure in which the upper and lower photonic devices (31, 32) are directly joined as described above, the lower photonic device 31 is made larger in width than the upper photonic device 32, in order to ensure electrical coupling to an electrode in a portion in which the upper and lower sides come into contact with each other. In other words, the extractor electrode 33 is formed in an exposed portion of the lower photonic device 31 not contacting the upper photonic device 32, in order to provide a common electrical coupling between the upper photonic device 31 and the lower photonic device 32. Further, the extractor electrode 36 is formed on the submount 35 on which the integrated photonic device is mounted, in order to provide an electrical coupling between the wavelength tunable semiconductor laser 11 and the semiconductor optical amplifier 12 in the lower photonic device 31.

FIGS. 3A and 3B are diagrams showing an example of a structure in which the two photonic devices (31, 32) are stacked in the vertical direction only in the light coupling portion of the total refection mirrors (27, 30) and the lens devices (28, 29). In the structure shown in FIGS. 3A and 3B, the upper photonic device 32 on the upper side, and the lower photonic device 31 on the lower side are mounted on the individual submounts 35 with different heights. As shown in the figures, the submount 35 may be two submounts with different heights, or may be a single submount having a step structure.

In the structure shown in FIGS. 3A and 3B, as seen from the top view of FIG. 3B, the axis direction along the optical waveguide of the upper photonic device 32 on the upper side, and the axis direction along the optical waveguide of the lower photonic device 31 on the lower side, are not linearly continued but are bent at 90 degrees.

As described above, the optical waveguides of the photonic devices (31, 32) are vertically integrated in such a way that the optical waveguides of the photonic devices (31, 32) are bent to each other in the joint portion. In this way, the total length of the integrated photonic device can be reduced to about half the length of the integrated photonic device formed by the conventional integration method for linearly joining the optical waveguides.

In the structure shown in FIGS. 3A and 3B, the area occupied by the integrated photonic device is larger than the structure shown in FIGS. 2A and 2B. This is advantageous in that the upper and lower photonic devices (31, 32) are likely to be thermally and electrically independent of each other.

Incidentally, it is necessary, to take into account the fact that when the upper and lower photonic devices (31, 32) are bent at 90 degrees as shown in FIGS. 3A and 3B, the polarization direction of light propagating through the upper optical waveguide and the lower optical waveguide is rotated by 90 degrees.

For example, in the case of integrating a laser with a tensile strain quantum well on the lower side to emit a laser beam with transverse magnetic (TM) polarization, the laser beam is transverse electric (TE) polarization when propagating in the optical waveguide on the upper side. Thus, it is necessary to design the photonic device integrated on the upper side to effectively operate with TE polarization. On the other hand, for example, in the case of integrating a laser with a compressive strain quantum well on the lower side to emit a laser beam with TE polarization, the laser beam is TM polarization in the optical waveguide on the upper side. Thus, it is necessary to design the photonic device integrated on the upper side to effectively operate with TM polarization.

Japanese Patent Application Laid-Open Publication No. 2004-273906 describes a method for irradiating a laser beam from a vertical laser in a direction perpendicular to a surface of a substrate, reflecting the irradiated light by a reflection mirror, and inputting the light into an optical amplifier. However, there is no description in Japanese Patent Application Laid-Open Publication No. 2004-273906 about the achievement of the integrated photonic device having a short device length by integrating the lower photonic device 31 and the upper photonic device 32 in the direction perpendicular to the substrate.

In particular, there is no description of the use of the 45-degree total reflection mirrors and the lens devices that are integrally formed in the upper photonic device 31 and the lower photonic device 32, respectively, to optically couple the upper and lower photonic devices 31 and 32. In other words, Japanese Patent Application Laid-Open Publication No. 2004-273906 does not disclose that light produced by the lower photonic device 31 is bent upward by the total reflection mirror formed in the end portion of the lower photonic device 31, totally reflected by the 45-degree total reflection mirror formed in the end portion of the upper photonic device 32, and coupled to the upper photonic device 32.

### Example of the Integrated Photonic Device

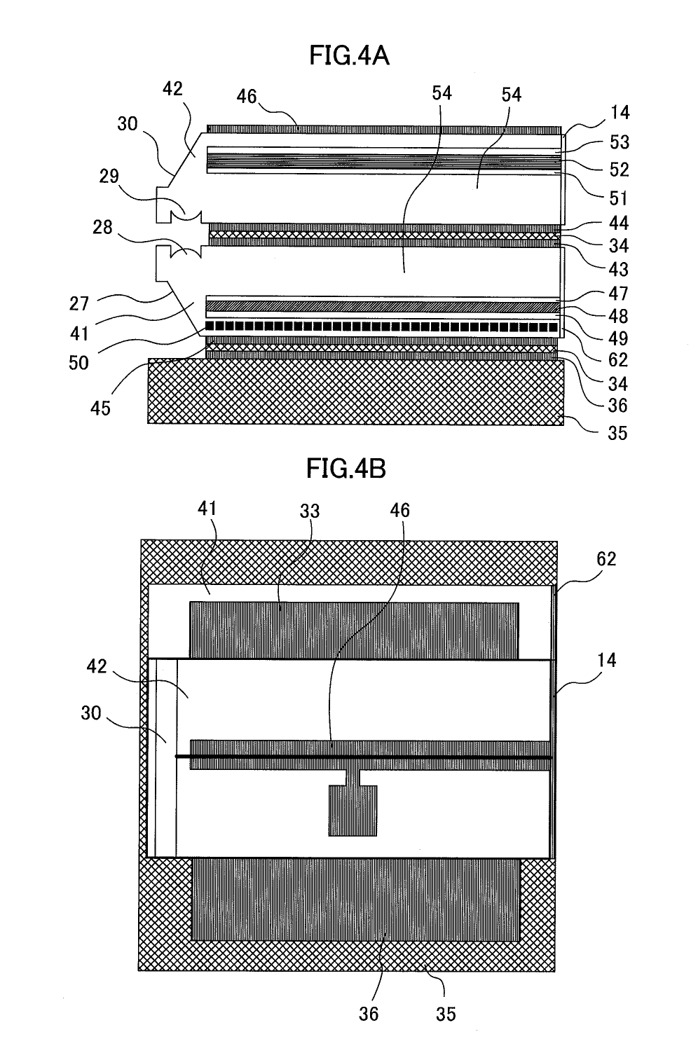

An example of an integrated photonic device to be installed in an optical module according to an embodiment of the present invention will be described below with reference to FIGS. 4 to 6.

FIGS. 4A and 4B are diagrams showing an example of an integrated photonic device to be installed in an optical module according to an embodiment of the present invention. FIG. 4A is a cross-sectional view and FIG. 4B is a top view.

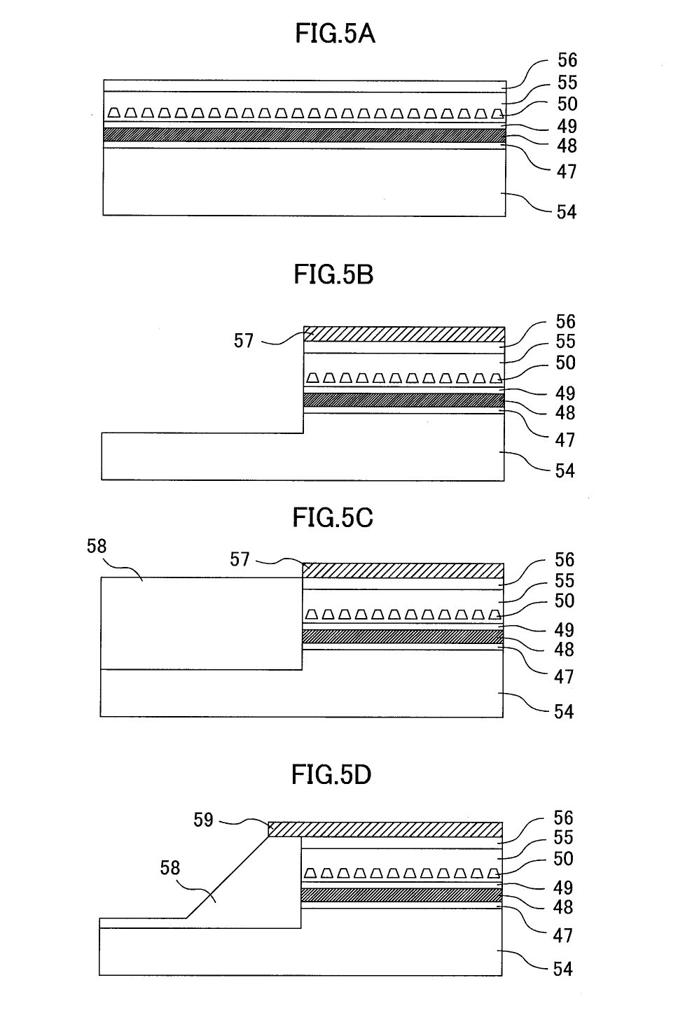

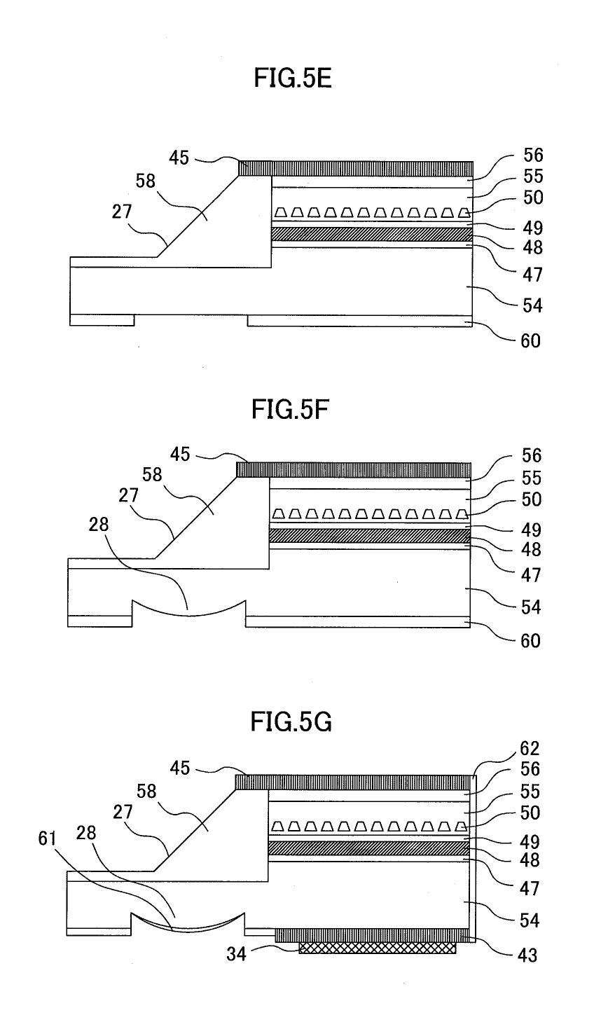

FIGS. 5A to 5G are cross-sectional views showing the fabrication procedure of a semiconductor laser portion of the integrated photonic device shown in FIGS. 4A and 4B.

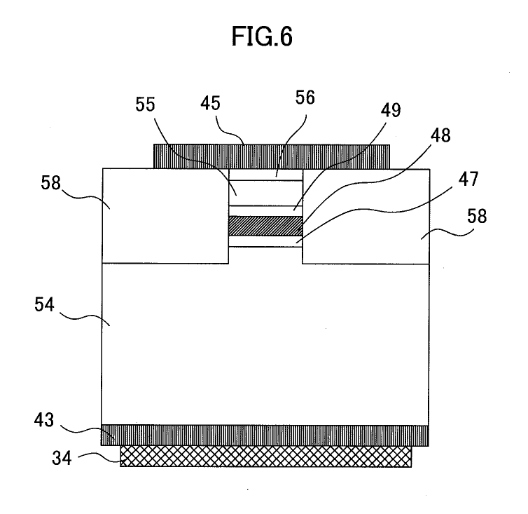

FIG. 6 is a cross sectional view in the plane intersecting the light traveling direction in the semiconductor laser portion of the integrated photonic device shown in FIGS. 4A and 4B.

The integrated photonic device shown in FIGS. 4A and 4B is an electro absorption (EA) modulator integrated laser with a lasing wavelength of 1.55 μm, in which a distributed feedback (DFB) semiconductor laser and an EA modulator are three-dimensionally integrated.

The integrated photonic device shown in FIGS. 4A and 4B includes a semiconductor laser portion 41 and a modulator portion 42 that are integrated in the direction perpendicular to the surface of the substrate. An n-electrode 43 of the semiconductor laser portion 41 and an n-electrode 44 of the modulator portion 42 are electrically coupled with the solder 34. Then, the n-electrode 43 of the semiconductor laser portion 41 and the n-electrode 44 of the modulator portion 42 are both coupled to the extractor electrode 33.

A p-electrode 45 of the semiconductor laser portion 41 and a p-electrode 46 of the modulator portion 42 are formed independently of each other. The p-electrode 45 of the semiconductor laser portion 41 is coupled to the extractor electrode 36.

The semiconductor laser portion 41 and the modulator portion 42 are optically coupled through the total reflection mirrors (namely, the 45-degree total reflection mirrors) (27, 30) and the lens devices (28, 29), each of which is integrally formed in the semiconductor laser portion 41 and the modulator portion 42.

In other words, a laser beam generated in the active layer of the semiconductor laser portion 41 is reflected and bent upward by the total reflection mirror 27 integrally formed in the semiconductor laser portion 41. The laser beam guided upward is collimated (narrowed or focused) by the lens device 28 integrally formed in the semiconductor laser portion 41. Then, the collimated light is incident to the modulator portion 42 on the upper side.

The light incident to the modulator portion 42 is focused by the lens device 29 integrally formed in the modulator portion 42. Then, the light is reflected by the total reflection mirror 30 integrally formed in the modulator portion 42, and is coupled to the optical waveguide of the modulator portion 42.

Incidentally, the optical waveguides of the semiconductor laser portion 41 and the modulator portion 42 are formed in a stripe shape, having a buried heterostructure (BH structure) (see FIG. 6). This structure is well known.

The stacked structure of the semiconductor laser portion 41 and the modulator portion 42 will be described below with reference to FIG. 4A. The semiconductor laser portion 41 and the modulator portion 42 are each designed to have an optimal structure. For this reason, the stacked structures of the semiconductor laser portion 41 and the modulator portion 42 are different from each other.

The semiconductor laser portion 41 includes an n-type InGaAlAs optical confinement layer 47, an InGaAlAs strained multiple quantum well 48, and a p-type InGaAlAs optical confinement layer 49. The quantum well layer, which is the active region, is designed to provide sufficient characteristics as a laser by stacking 5 periods of a 7 nm thick well layer and an 8 nm thick barrier layer. Under the stacked layers, a grating layer 50 of InGaAsP-based material is formed. The structure of the active region and the grating layer 50 is formed so that the lasing wavelength of the DFB laser is 1550 nm at room temperature.

Here, the optical confinement layers (47, 49) are formed with the quantum well layer 48 between them in order to enhance optical confinement of the quantum well 48.

The optical waveguide function is generated by sandwiching the core region between cladding layers having a lower refractive index than the core region. In other words, the optical waveguide function is provided by the stacked structure of cladding layer/quantum well layer/cladding layer. However, in the practical application, the optical confinement layers (47, 49) are formed by sandwiching the quantum well layer 48 in order to enhance the optical confinement in the quantum well layer 48.

For the above purpose, the refractive index of the cladding layers is set to a lower value than the refractive index of the optical confinement layers. In the semiconductor laser portion 41 shown in FIGS. 4A and 4B, the role of the cladding layer on the substrate side is played by the substrate itself. However, as a matter of course, a cladding layer can be formed on the substrate side independently of the semiconductor substrate.

The polarity of the grating layer 50 can be both n-type and p-type. In the case of p-type polarity, the DFB laser is an index coupled DFB laser with only the refractive index periodically changing in the light propagation direction. Further, in the case of n-type polarity, the DFB laser is a grain coupled DFB laser. As is well known, the grating functions as a periodic current blocking layer, so that a periodic change occurs not only in the refractive index but also in the gain of the active layer.

In FIGS. 4A and 4B, there has been described the grating evenly formed over the entire region of the DFB laser. However, it is also possible to use the so-called phase shift structure in which the phase of the grating is shifted in a portion of the region, according to the necessity.

In the modulator portion 42, an n-type InGaAlAs optical confinement layer 51, an undoped absorption layer 52, and an undoped InGaAlAs optical confinement layer 53 are formed. The absorption layer 52 has an InGaAlAs-based strained multiple quantum well structure to exhibit good characteristics as the EA modulator. The thickness of the quantum well is set to 8 nm, and the thickness of the barrier layer is set to 5 nm. The quantum well and the barrier layer are stacked 10 periods. The reason why the thickness of the barrier layer of the modulator portion 42 is made thicker than the thickness of the semiconductor laser portion 41, is to facilitate the movement of the carrier in the absorption layer to improve the modulator characteristics.

Next, the fabrication procedure of the semiconductor laser portion 41 shown in FIGS. 4A and 4B will be described with reference to FIGS. 5A to 5G.

First, the structure of the semiconductor laser portion 41 is formed by stacking an n-type InGaAlAs optical confinement layer 47, an InGaAlAs strained multiple quantum well layer 48, and a p-type InGaAlAs optical confinement layer 49 on an n-type InP substrate 54.

Further, on the above stacked layers, a multi-layer structure including a grating layer 50 of an InGaAsP based material is formed. Then, a p-type InP cladding layer 55 and a p-type InGaAs contact layer 56 are further formed on the multi-layer structure (see FIG. 5A).

The InP wafer having such a multi-layer structure is covered with a silicon dioxide 57 as a protective mask.

Using the silicon dioxide mask 57, as shown in FIG. 5B, the optical waveguide is formed by etching the contact layer 56, the p-type cladding layer 55, the grating layer 50, the optical confinement layer 49, the strained multiple quantum well layer 48, the optical confinement layer 47, and a part of the InP substrate 54. This etching can be performed, for example, by dry etching such as reactive ion etching (RIE) with a chlorine based gas, or wet chemical etching with a bromine-based solution and the like, or the combination of dry etching and wet chemical etching.

Next, the sample is placed in an epitaxial growth reactor, in which a Fe-doped semi-insulating InP layer 58 is buried in the sample and is grown at 600° C. by MOVPE method (see FIG. 5C).

The buried heterostructure is formed by the etching process and by the regrowth process of the buried layer. The buried heterostructure is a structure in which both sides of the optical waveguide in the light traveling direction are filled with a material that can confine light in the optical waveguide.

In general, the material for confinement is a high resistance material. In this example, the Fe-doped semi-insulating InP 58 with a high resistance is used. FIG. 6 is a cross-sectional view in the plane intersecting the light traveling direction in the device. FIG. 6 will provide a thorough understanding of the buried structure.

In the fabrication procedure of the buried structure, the both sides of the optical waveguide in the light traveling direction are buried with the semi-insulating InP 58, and at the same time the end on the light output side of the optical waveguide is also buried with the semi-insulating InP 58. The reason why the optical waveguide is buried with the InP material, is that the portion of only InP material is etched to form the 45-degree total reflection mirror, making it easy to form the etched mirror perfectly flat and smooth.

Then, the silicon dioxide 57 used as the selective growth mask for regrowth, is removed to form a silicon nitride film 59 for etching mask. Then, the Fe-doped semi-insulating InP layer 58 is etched at an inclined angle of 45 degrees (see FIG. 5D).

With such an angled etching using chemically assisted ion beam etching (CAIBE) with chlorine and argon gases, the wafer is etched at an angle of 45 degrees to produce a 45 degree etched facet. Although the etching method using CAIBE is used in this example, other etching methods can also be used such as reactive ion beam etching (RIBE) with a chlorine-based gas as well as wet chemical etching.

Next, after the silicon nitride 59 is removed, the p-electrode 45 is deposited on the p-type InGaAs contact layer 56. Further, the rear surface of the substrate is polished to a thickness of 100 μm, and a silicon nitride mask 60 with a circular opening is formed on the rear surface of the substrate (see FIG. 5E). Then, the portion to be the lens device is etched to a depth of 20 μm. In this way, taking advantage of the characteristics of the wet chemical etching with hydrogen bromide having diffusion limited in which the etching is deeper as it approaches the silicon nitride mask 60, the lens device 28 is formed on the rear surface of InP (see FIG. 5F). Here, the height of protrusion of the lens device 28 is 5 μm, and the radius of the lens device 28 is 40 μm. Next, the silicon nitride mask 60 is completely removed, and an anti-reflective coating 61 of silicon nitride oxide is formed on a surface of the lens device 28. Further, the n-electrode 43 and the AuSn solder 34 are formed using common deposition and lift off methods. On the rear end facet of the device, a highly reflective coating film 62, which is used for typical semiconductor devices, is formed (see FIG. 5G). The fabricated semiconductor laser portion 41 has a device length of 300 μm and a width of 300 μm.

Next, the fabrication procedure of the modulator portion 42 will be described.

The fabrication procedure of the modulator portion 42 is substantially the same as the fabrication procedure of the semiconductor laser portion 41, except for the semiconductor multi-layer structure. Thus, only the outline is described here with reference to FIG. 4A.

First, an absorption layer region of the EA modulator is formed on the n-type InP substrate 54 by the MOVPE method. The absorption layer region of the EA modulator includes an n-type InGaAlAs optical confinement layer 51, an InGaAlAs-based multiple quantum well absorption layer 52, and an undoped InGaAlAs optical confinement layer 53. Then, a p-type InP cladding layer and a p-type InGaAs contact layer are formed (not shown). After the above epitaxial growth process, the modulator portion 42 is fabricated by integrating the lens device 29 and the 45-degree total reflection mirror 30 by the same fabrication procedure as the fabrication procedure of the semiconductor laser portion 41. It should be noted that the modulator portion 42 is different from the semiconductor laser portion 41 in that the solder is not formed on the n-electrode in the modulator portion 42. The fabricated modulator portion 42 has a device length of 300 μm and a width of 200 μm.

Finally, the semiconductor laser portion 41 is mounted on the submount 35 in which the extractor electrode pattern 36 is formed so that the lens device forming surface faces upward. Then, the EA modulator portion 42 is mounted on the semiconductor laser portion 41 so that the lens device forming surface faces downward.

At this time, the semiconductor laser portion 41 and the EA modulator portion 42 are bonded by the AuSn solder 34 that is formed on the n-electrode 45 of the semiconductor laser portion 41. Further, the semiconductor laser portion 41 mounted on the lower side is larger than the EA modulator portion 42 mounted on the upper side. With this configuration, the n-electrode 43 of the semiconductor laser can be electrically coupled to the n-electrode 44 of the EA modulator by the extractor electrode 33 formed on a surface of the semiconductor laser portion 41 not contacting the EA modulator portion.

In FIGS. 4A and 4B, the EA modulator integrated laser achieves a very compact size with a total device length of 300 μm, reflecting the effect of the present invention. Further, the EA modulator integrated laser exhibits good characteristics with a threshold current of 10 mA and a slope efficiency of 0.4 W/A in the continuous wave operation at room temperature.

Further, with respect to the EA modulator integrated laser shown in FIGS. 4A and 4B, the result of the automatic power control test at 50° C. and 5 mW has exhibited 100 million hours as the life time. This has proved that the EA modulator integrated laser shown in FIGS. 4A and 4B has a high reliability.

In the example shown in FIGS. 4A and 4B, the light emitting end facet of the EA modulator portion 42, and the end facet of the semiconductor laser portion 41 are aligned with each other. In this case, the emitted light from the EA modulator portion 42 does not hit the upper surface of the semiconductor laser portion 41. However, there is a problem in which the device length of the EA modulator portion 42 is less than the device length of the semiconductor laser portion 41, with the end facet of the EA modulator portion 42 retreated by a distance R from the end facet of the semiconductor laser portion 41. In this case, it is necessary to design the modulator portion 42 to satisfy the following formula: R<T/tan(θ/2), where θ is the far-field pattern angle and T is the thickness of the modulator portion 42, in order to prevent the emitted light from hitting the upper surface of the semiconductor laser portion 41.

### Example of the Integrated Photonic Device

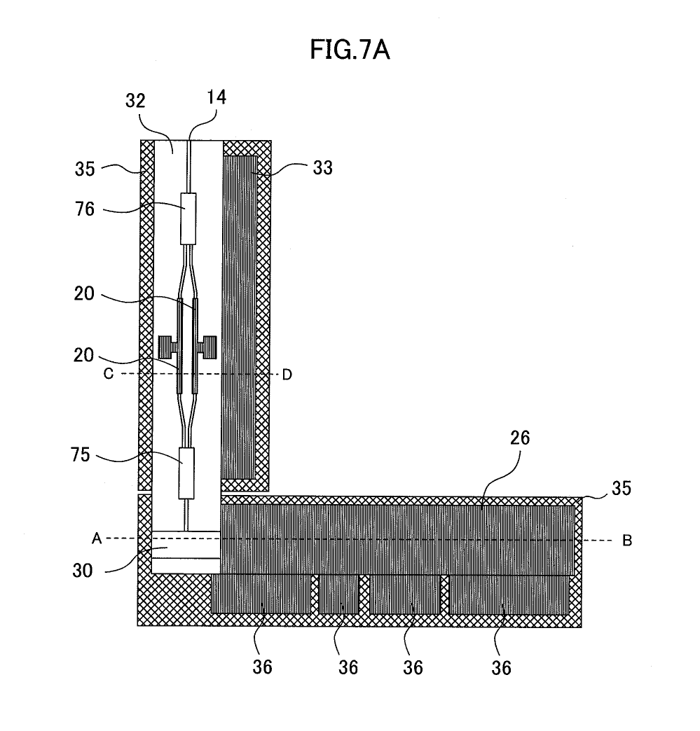

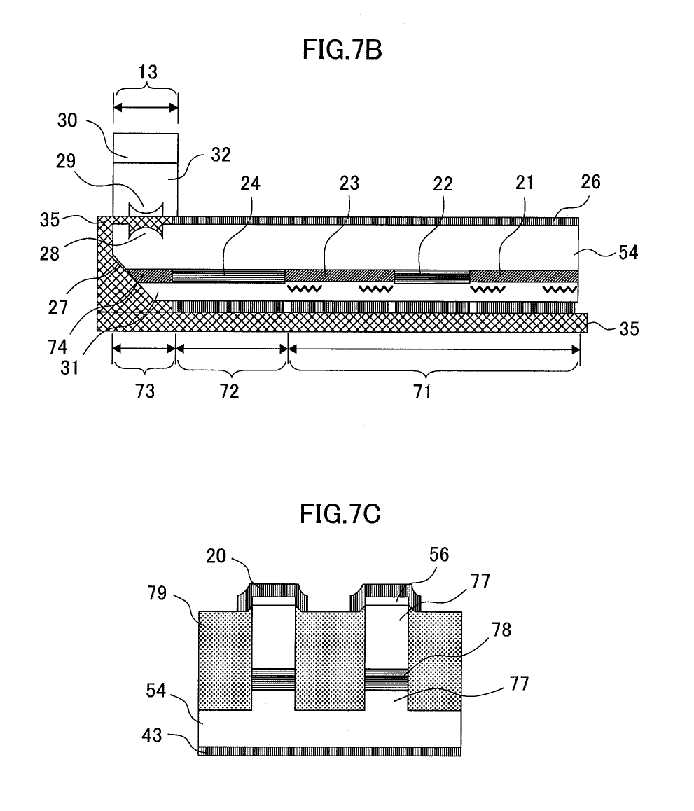

FIGS. 7A to 7C are diagrams showing another example of the integrated photonic device to be installed in the optical module according to an embodiment of the present invention. FIG. 7A is a top view, FIG. 7B is a cross-sectional view, and FIG. 7C is a cross-sectional view. More specifically, FIG. 7B shows the cross sectional structure taken along the dotted line (A to B) in the top view of FIG. 7A, while FIG. 7C shows the cross sectional structure taken along the dotted line (C to D) in the top view of FIG. 7A.

In FIGS. 7A to 7C, the integrated photonic device is a Mach-Zehnder modulator integrated wavelength tunable laser with the lasing wavelength of 1.55 μm, in which a sampled grating distributed Bragg reflector (SG-DBR) wavelength tunable laser and a Mach-Zehnder (MZ) modulator are three-dimensionally integrated.

The integrated photonic device shown in FIGS. 7A to 7C has a structure in which two integrated photonic devices, which are mounted on the individual submounts 35, are three-dimensionally stacked in the direction perpendicular to the substrate.

The lower photonic device (first integrated photonic device) 31 formed on the lower side is a device in which an SG-DBR wavelength tunable laser 71, a semiconductor optical amplifier 72, and a low loss optical waveguide region 73 are monolithically integrated on the InP substrate 54 by the butt joint technique. The lower photonic device 31 has a light emitting portion in which the total reflection mirror 27 formed by etching, as well as the lens device 28 are integrally formed.

The SG-DBR wavelength tunable laser 71 has a structure in which the gain region 22 of the 5-period InGaAsP compressive strained multiple quantum well is sandwiched by two SG-DBR regions (rear sampled gating DBR 21 and front sampled gating DBR 23) with different longitudinal-mode distances.

Here, SG-DBR is a structure in which a portion of a pair of regions, one having grating and the other not, is defined as one period which is repeated several times.

The structure of the gain region 24 of the semiconductor optical amplifier 72 is the same as the structure of the gain region 22 of the wavelength tunable laser including the InGaAsP strained quantum well. The low loss optical waveguide region 73 has an optical waveguide 74 of InGaAsP with a band gap wavelength of 1.3 μm. In FIGS. 7A to 7C, the reference numeral 26 denotes an n-electrode.

The lengths of the SG-DBR wavelength tunable laser 71, semiconductor optical amplifier 72, and low loss optical waveguide region 73 are 1.3 mm, 600 μm, and 100 μm, respectively. As a result, the total device length is 2 mm.

Further, the angle of the total reflection mirror 27 is 45 degrees. Light generated by the SG-DBR wavelength tunable laser 71 is amplified by the semiconductor optical amplifier 72. Then, the amplified light is totally reflected and guided upward. The lens device 28 with a diameter of 60 μm and a curvature radius of 100 μm has a function of collimating (narrowing or focusing) the light to emit a substantially collimated light. The lens surface for emitting a laser beam, and the end facet of the rear SG-DBR region are both coated with an anti reflective coating (not shown) with a reflectance of 1% or less.

The upper photonic device (second integrated photonic device) 32 formed on the upper side is a device in which the semiconductor Mach-Zehnder modulator 13, the total reflection mirror 30, and the lens device 29 are monolithically integrated. The semiconductor Mach-Zehnder modulator 13 is formed on the InP substrate 54. As shown in FIG. 7A, the semiconductor Mach-Zehnder modulator 13 has two optical waveguides that are coupled between two multi-mode interference (MMI) couplers, namely, an MMI coupler 75 coupled to an input-side optical waveguide and an MMI coupler 76 coupled to an output-side optical waveguide.

On the two optical waveguides, a pair of phase modulation p-electrodes 20 are formed through the p-type InGaAs contact layer 56. In FIG. 7C, reference numeral 43 denotes an n-electrode.

As shown in FIG. 7C, the optical waveguide has a multi-layer structure of a 20-period InGaAsP non-strained multiple quantum well (MQW) 78 that is sandwiched between upper and lower InP cladding layers 77.

The lateral structure of the optical waveguide is the so-called high-mesa structure, in which a deep mesa is formed by etching through the multiple quantum well layers. The etching of the high-mesa structure is performed by reactive ion etching (RIE) using inductively coupled plasma (ICP) of chlorine gas. Further, both sides of the mesa structure are filled with polyimide 79

The total reflection mirror 30 integrally formed in the upper photonic device 32 has an angle of 45 degree, so that the light emitted from the lower photonic device 31 and focused by the lens device 29, is totally reflected by the 45-degree total reflection mirror 30. Then, the light is coupled to the input-side optical waveguide.

The device length of the upper-side optical waveguide 32 is 1.5 mm. The lens surface for receiving the incident laser beam, and the end facet for emitting the modulated laser beam are both coated with the anti reflective coating with the reflectance of 1% or less (not shown).

The upper photonic device 32 is mounted on the submount 35 that is thicker than the lower photonic device 31 by 100 μm. The upper photonic device 32 is placed higher than the lower photonic device 31 by the thickness of the lower photonic device 31, so that the light emitted upward from the lower photonic device 31 is input to the upper photonic device 31.

Further, the lower photonic device 31 and the upper photonic device 32 are placed in such a way that the optical waveguide direction is bent by 90 degrees, as seen from the top of the joint portion. Thus, although the integrated photonic device shown in FIGS. 7A to 7C is fabricated by integrating the optical amplifier integrated wavelength tunable laser of 2 mm length and the modulator of 1.5 mm length, the total device length can be suppressed to 2 mm.

In FIGS. 7A to 7C, the Mach-Zehnder modulator integrated wavelength tunable laser has a very small size with a total device length of 2 nm, reflecting the effect of the present invention, in which single-mode lasing has been observed at a light output of 20 mW or more in a wavelength region of 40 nm from 1525 nm to 1565 nm. In addition, a dynamic extinction ratio of 12 dB has been obtained in the wavelength region of 1530 nm to 1560 nm in a push-pull operation at a driving voltage of 3V.

Further, with respect to the Mach-Zehnder modulator integrated wavelength tunable laser shown in FIGS. 7A to 7C, the result of the automatic power control test at 80° C. and 10 mW has exhibited 150 million hours as the life time. This has proved that the EA modulator integrated laser shown in FIGS. 7A to 7C has a high reliability.

In the above description, the upper photonic device 32 uses only the semiconductor Mach-Zehnder modulator having the non-strained InGaAsP multiple quantum well structure that operates with the same characteristics, regardless of the difference in the polarization between TE and TM. Thus, there is no particular consideration of the polarization direction of light.

However, as shown in FIGS. 7A to 7C, when the upper photonic device 32 and the lower photonic device 31 are integrated by bending the upper and lower optical waveguides, and when the two photonic devices 31 and 32 both have a strong polarization dependence, it is necessary to take into account the polarization direction of light.

For example, it is assumed that the lower photonic device 31 has a laser using the strained multiple quantum well as the active layer, and the upper photonic device 32 has an optical amplifier using the strained multiple quantum well as the gain region. In this case, when the strained multiple quantum well laser is compressive strain, the laser beam is TE polarization. The light propagates to the upper photonic device 32 as TM polarization. Thus, the gain region of the optical amplifier in the upper photonic device 32 should have a tensile strained multiple quantum well structure to better operate for TM polarization.

In FIGS. 7A to 7C, the description has focused on the Mach-Zehnder modulator integrated wavelength tunable laser with the lasing wavelength of 1.55 μm. However, the present invention can also be applied to a device with a lasering wavelength of 1.3 μm.

Further, in the above description, the present invention is applied to the Mach-Zehnder modulator integrated wavelength tunable laser, but the present invention is not limited to this example. The present invention can also be applied to other integrated photonic devices such as a beam expander integrated laser. Further, in the integrated photonic device shown in FIGS. 7A to 7C, the two photonic devices (31, 32) are both formed on the InP substrate. However, a photonic device formed on a GaAs substrate can also be used, such as, for example, a semiconductor laser using a GaInNAs quantum well structure.

Still further, in the above description, the two photonic devices (31, 32) are mounted in such a way that the two photonic devices are bent at an angle of 90 degrees, but the angle is not necessarily 90 degrees. For example, the two photonic devices (31, 32) can be mounted at an angle of 80 or 110 degrees.

### Embodiment

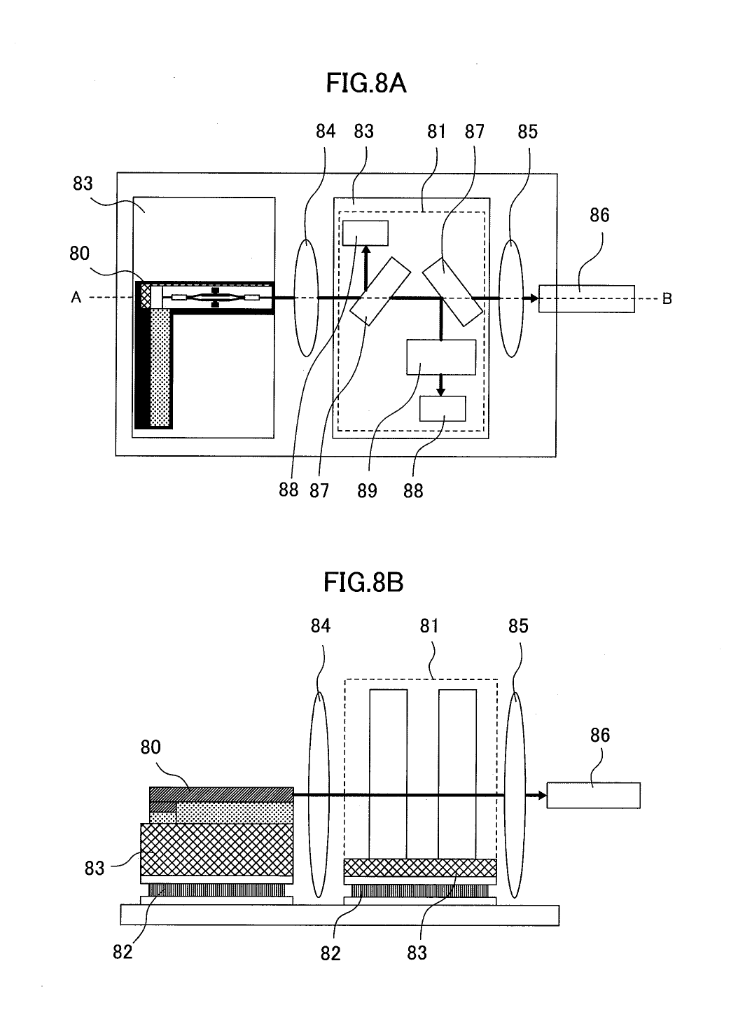

Hereinafter an embodiment of the present invention will be described with reference to FIGS. 8A and 8B.

FIGS. 8A and 8B are diagrams showing an optical module according to an embodiment of the present invention. FIG. 8A is a top view and FIG. 8B is a cross-sectional view. More specifically, FIG. 8B shows the cross-sectional structure taken along the dotted line (A to B) in the top view of FIG. 8A.

The present embodiment is an optical transceiver module including a Mach-Zehnder modulator integrated wavelength tunable laser (integrated light source) and a wavelength locker.

The optical module according to the present embodiment includes a Mach-Zehnder modulator integrated wavelength tunable laser (hereinafter referred to as an integrated light source) 80, and a wavelength locker 81. Each of the integrated light source 80 and the wavelength locker 81 is mounted on a mounting substrate 83 of AlN on a Peltier device 82.

A light beam emitted from the integrated light source 80 is converted into a collimated light by a lens 84 provided forward the integrated light source 80, and input to the wavelength locker 81. The light beam passing through the wavelength locker 81 is focused by the lens 85, and is coupled to an optical fiber 86. Then, the light beam propagates to the outside of the module.

The wavelength locker 81 is a component having two beam splitters 87, two photodiodes 88, and one etalon filter 89 to stabilize the wavelength.

The wavelength locker 81 monitors the wavelength by comparing the light intensities of the light emitted from the integrated light source 80 before and after passing through the etalon filter 89. The monitoring result is fed back to the driving conditions of the integrated light source 80. In this way, it is possible to obtain a laser beam with very accurately controlled wavelength.

As described above, the integrated light source 80 used in this embodiment is short with the total device length of 2 mm. As a result, the length of the module can be reduced by 2 mm, compared to the case of using the conventional integrated light source of the total length of 4 mm. Further, the transmission characteristics of 10 Gbps have been evaluated using the optical module according to the present embodiment. As a result, error-free transmission characteristics of 100 km have been obtained in the four wavelengths of 1530, 1540, 1550, and 1560 nm. The power penalty is 3 dB or less.

In this embodiment, the Mach-Zehnder modulator integrated wavelength tunable laser shown in FIGS. 7A to 7C is installed in the optical module. However, another structure is also possible in which the EA modulator integrated laser shown in FIGS. 4A and 4B is installed in the optical module.

While the invention made by the present inventors has been described in detail based on the embodiment, it will be appreciated that the present invention is not limited to the embodiment described hereinbefore and various modifications and changes may be made thereto without departing from the spirit and scope of the invention.

What is claimed is:

1. An optical module comprising an integrated photonic device fabricated by integrating a plurality of optical waveguide devices,
wherein the integrated photonic device has a first optical waveguide device portion and a second optical waveguide device portion that are three-dimensionally stacked in a direction perpendicular to a substrate,
wherein the first optical waveguide device portion has a reflector for emitting light in a direction perpendicular to a surface of the substrate, so that the emitted light propagates through a first optical waveguide,
wherein the second optical waveguide device portion has a reflector for introducing light incident from the direction perpendicular to the surface of the substrate, into a second optical waveguide.

2. The optical module according to claim 1,
wherein the first optical waveguide device portion is mounted on a submount,
wherein the second optical waveguide device portion is mounted on the first optical waveguide device portion.

3. The optical module according to claim 2,
wherein an electrode is formed in a region in which the length in the direction orthogonal to the extending direction of the first optical wavelength in the first optical wavelength device portion, is longer than the length in the direction orthogonal to the extending direction of the first optical waveguide in the second optical waveguide device portion mounted on the first optical waveguide device portion, and in which the first optical waveguide device portion does not contact the second optical waveguide device portion.

4. The optical module according to claim 1,
wherein the first optical waveguide device portion has a lens device for focusing the emitted light onto a light emitting portion for emitting light in the direction perpendicular to the surface of the substrate,
wherein the second optical waveguide device portion has a lens device for focusing the incident light onto a light receiving portion for receiving light incident from the direction perpendicular to the surface of the substrate.

5. The optical module according to claim 1,
wherein the first optical waveguide device portion has at least one wavelength tunable laser and at least one semiconductor optical amplifier,
wherein the second optical waveguide device portion has at least one optical modulator.

6. An optical modulator comprising an integrated photonic device fabricated by integrating a plurality of optical waveguide devices,
wherein the integrated photonic device has a first optical waveguide device portion and a second optical waveguide device portion that are three-dimensionally stacked in a direction perpendicular to a substrate,
wherein the first optical waveguide device portion has a reflector for emitting light in a direction perpendicular to a surface of the substrate, so that the emitted light propagates through a first optical waveguide,
wherein the second optical waveguide device portion has a reflector for introducing light incident from the direction perpendicular to the surface of the substrate, into a second optical waveguide,
wherein the first optical waveguide device portion and the second optical waveguide device portion are mounted on submounts with different heights,
wherein the first optical waveguide of the first optical waveguide device portion, and the second optical waveguide of the second optical waveguide device portion are not linearly continued but are bent to each other in the joint portion, when projected in the direction perpendicular to the main surface of the substrate.

7. The optical module according to claim 6,
wherein the first optical waveguide device portion has a structure for operating with TM polarization,
wherein the second optical waveguide device portion has a structure for operating with TE polarization.

8. The optical module according to claim 6,
wherein the first optical waveguide device portion has a structure for operating with TE polarization,
wherein the second optical waveguide device portion has a structure for operating with TM polarization.

9. The optical module according to claim 6,
wherein the first optical waveguide device portion has a lens device for focusing the emitted light onto a light emitting portion for emitting light in the direction perpendicular to the surface of the substrate,
wherein the second optical waveguide device portion has a lens device for focusing the incident light onto a light receiving portion for receiving light incident from the direction perpendicular to the surface of the substrate.

10. The optical module according to claim 6,
wherein the first optical waveguide device portion has at least one wavelength tunable laser and at least one semiconductor optical amplifier,
wherein the second optical waveguide device portion has at least one optical modulator.
